(19) United States
(12) Patent Application Publication
(10) Pub. No.: US 2008/0183911 A1
(43) Pub. Date: Jul. 31, 2008

(54) HANDS-FREE CONTROLLER

(76) Inventors: Kevin Patrick Hurley, Miami, FL (US); Stuart R. Ehrlich, Boston, MA (US)

Correspondence Address: MICHAEL RIES, 318 PARKER PLACE, OSWEGO, IL, 60543, US

(21) Appl. No.: 12/020,291

(22) Filed: Jan. 25, 2008

Related U.S. Application Data
(60) Provisional application No. 60/897,459, filed on Jan. 25, 2007.

(51) Int. Cl. G06F 3/00; G06F 17/00

(52) U.S. Cl. 710/15; 700/94

(57) ABSTRACT

The present invention is a hands free controller with a foot controlled handsfree pushbutton based wireless remote control electronic device designed specifically for the seamless and simple integration with digital music devices (DMD) such as the iPod/MP3/Zune and provides: hands-free control of playback and volume, and the ability to navigate and select from menus and play lists on digital music devices (DMD's).

This application claims priority to U.S. Provisional Application 60/897,459 filed Jan. 25, 2007, the entire disclosure of which is incorporated by reference.

### TECHNICAL FIELD & BACKGROUND

The present invention generally relates to a hands free controller. More specifically, the present invention is a foot controlled handsfree pushbutton based wireless remote control electronic device.

The present invention is a foot controlled handsfree pushbutton based wireless remote control electronic device designed specifically for the seamless and simple integration with digital music devices (DMD) such as the iPod/MP3/Zune and provides: hands-free control of playback and volume, and the ability to navigate and select from menus and play lists on digital music devices (DMD's).

The hands free controller core product of the present invention consists of two separate electronic parts, the hands free controller device which contains a proprietary wireless transmitter, and the hands free controller receiver which attaches to a DMD accessory connector. The hands free controller receiver has a pass thru connector to allow other DMD accessories to be used at the same time.

The hands free controller device is powered by a standard 9V battery or power supply. The hands free controller device has 5 rugged pushbuttons to control the DMD, and light emitting diodes to indicate its operational status. The hands free controller device may have an attachment for a volume pedal or the volume may be controlled internally. Multiple hands free controller devices can control multiple DMD's without interference.

The hands free controller receiver may be plugged into the docking socket of the DMD and this receiver has a pass through connector to allow other DMD accessories to be used simultaneously. The hands free controller device contains a microcomputer chip and a low-power transmitter. The microcomputer continually polls the status of the pushbuttons and the volume control. If there is a change in any pushbutton or volume control, the microcomputer determines which operation is to be presented to the DMD. A software command sequence is built in to instruct the DMD to perform the operation. This command sequence is then transmitted to the hands free controller receiver.

When the hands free controller receiver receives a command sequence, it may convert the sequence to an DMD specific sequence, and then transmits this sequence to the DMD command input port.

The present invention uses the following technologies to implement the hands free controller device.

1) position dependent control (PDC)—A device that can be set by the user in a continuous range to specify a control value. The control value is deterministically set by the position of the device using potentiometers (electronic components that are used to vary, or control, the amount of current that flows through an electronic circuit. A potentiometer value is determined by the physical position of the potentiometer. A foot controlled volume pedal is an example of a device that uses a potentiometer)
2) non-position dependent control (NPDC)—A device that uses buttons or a rotary control to indicate the control value should be monotonically increased or decreased. An example is a media player device with two volume buttons, one button specifying the volume level should increase, one button specifying the volume level should decrease.
3) control value—the value returned by the control. The units and minimum and maximum value are dependent on the specific control. Regardless, the control value can be specified as a percent of it's maximum value. Thus a control at it's minimum value can be referred to as 0% control value, and a control at it's maximum value can be referred to as 100% control value.
4) monotonically—Changing in one direction only; thus either strictly rising or strictly rising or falling, but not reversing direction.
5) control up-operation—A single execution of a NPDC's value incrementing operation.
6) control down-operation—A single execution of a NPDC's value decrementing operation.
7) control increment percent (CIP)—the change in percent of control value from a single operation of a non-position dependent control. This can be determined by counting the number of operations that change the control value from 0% to 100%, then dividing 100 by this count. The result is the percent change for a single operation. For example, if 25 control up operations are needed to go from 0% to 100%, then the control increment would be 4%.

### Method Description:

The present invention method involves two procedures.

The first is an initial procedure to set the NPDC to a known value. This is done by multiple occurrences of the NPDC's control-down operation to ensure the control value is set to 0%. For example, if the control increment is 4%, then 25 control down-operations are needed to guarantee the control value is set to 0% from any arbitrary setting. Then a default known control setting can be set by a specific number of control up-occurrences. For example, if the default control value is to be 40%, then 10 control up-operations are needed to achieve this control value from a 0% control value (assuming a 4% control increment of the NPDC).

The second procedure incurres each time the PDC is repositioned, or periodically based on a timer. The PDC's control value is calculated by scaling the PDC's value. The difference between the new control value and the previous control value is calculated. The amount of NPDC operations is calculated by dividing this difference by the control increment. If the difference is positive, indicating a value increase, the NPDC up-operation is executed this number of times. If the difference is negative, indicating a value decrease, the NPDC down-operation is executed this number of times.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a drawing of a hands free controller, in accordance with one embodiment of the present invention;

FIG. 2 illustrates a drawing of a hands free controller, in accordance with one embodiment of the present invention;

FIG. 3 illustrates a drawing of a hands free controller, in accordance with one embodiment of the present invention; and

FIG. 4 illustrates a drawing of a hands free controller, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

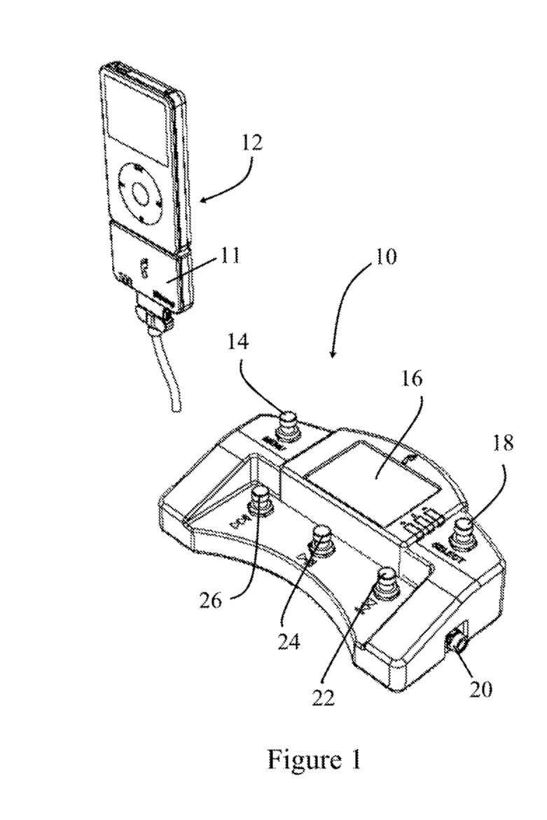

Referring now to FIG. 1, as in one embodiment illustrated is a hands-free controller 10 and hands free controller receiver 11. Shown is an IPOD device 12 connected to the hands free controller receiver 11. A menu button 12, select button 18 are on either side of a display 16 that may be a LCD display. A fast forward or shuffle down button 22, start/stop button 24 and reverse/shuffle up button 26 are shown. A jack 20 may be on hands-free controller 10.

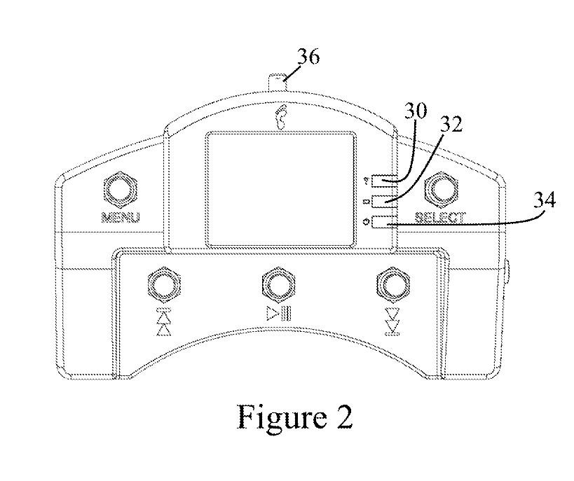

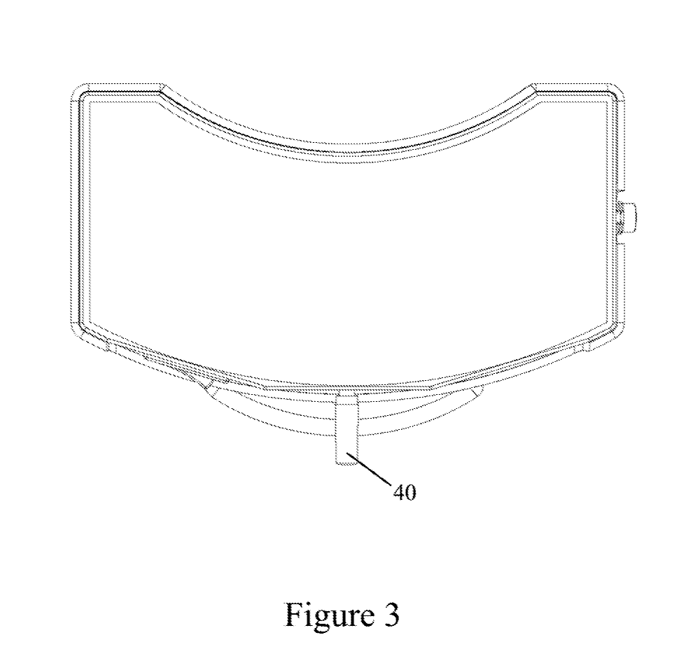

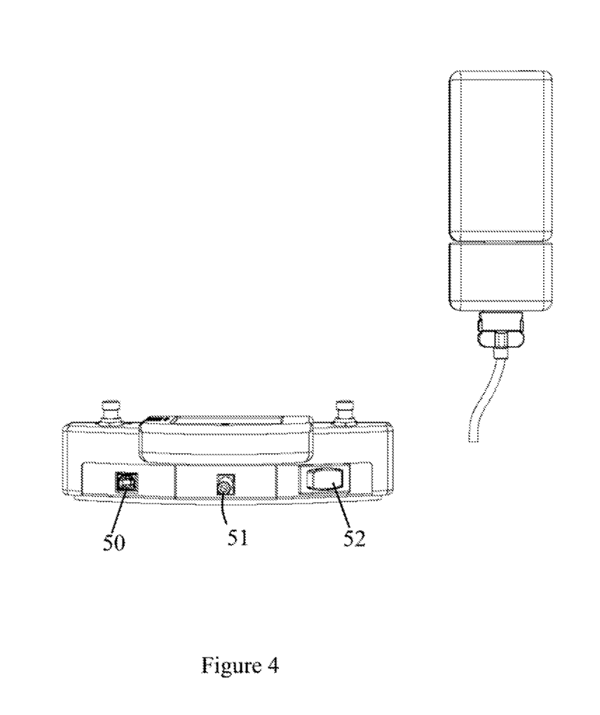

In FIG. 2 as in one embodiment a top view shows indicator or status lights for battery low 32, on or battery on 34 and connection to IPOD 30. Antenna 36 is shown. In FIG. 3 as in one embodiment a bottom view shows antenna 40. In FIG. 4 as in one embodiment a back view shows a USB port 50, antenna 51 and on/off switch 52.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A device comprising:
at least one push button operated by a foot of a user;
a transmitter electrically connected to the at least one push button; and
a receiver adapted to attach to a digital music device accessory connector and receiving functions from the at least one push button.

2. The device of claim 1 wherein the receiver has a pass thru connector to allow other DMD accessories to be used at the same time.

3. The device of claim 1 wherein the device has 5 rugged pushbuttons to control the DMD, and light emitting diodes to indicate its operational status.

4. The device of claim 1 wherein the device has an attachment for a volume pedal.

5. The device of claim 1 wherein multiple devices can control multiple DMD's without interference.

6. The device of claim 1 wherein the receiver is plugged into a docking socket of the DMD and the receiver has a pass through connector to allow other DMD accessories to be used simultaneously.

7. The device of claim 1 wherein the device contains a microcomputer chip and a low-power transmitter the microcomputer continually polls the status of the pushbuttons if there is a change in any pushbutton, the microcomputer determines which operation is to be presented to the DMD a software command sequence that is built to instruct the DMD to perform the operation this command sequence is then transmitted to the receiver when the receiver receives a command sequence, to convert the sequence to an DMD specific sequence, and then transmits this sequence to the DMD command input port.

8. A method comprising:
setting a NPDC to a known value; and
repositioning a PDC.

9. The method of claim 8 wherein the setting a NPDC to a known value is done by multiple occurrences of the NPDC's control-down operation to ensure the control value is set to 0%, if the control increment is 4%, then 25 control down-operations are needed to guarantee the control value is set to 0% from any arbitrary setting, then a default known control setting can be set by a specific number of control up-occurrences, if the default control value is to be 40%, then 10 control up-operations are needed to achieve this control value from a 0% control value assuming a 4% control increment of the NPDC.

10. The method of claim 8 wherein the repositioning of the PDC
is done each time the PDC is repositioned, or periodically based on a timer, the PDC's control value is calculated by scaling the PDC's value, the difference between the new control value and the previous control value is calculated, the amount of NPDC operations is calculated by dividing this difference by the control increment, if the difference is positive, indicating a value increase, the NPDC up-operation is executed this number of times, if the difference is negative, indicating a value decrease, the NPDC down-operation is executed this number of times.
